(19) United States
(12) Patent Application Publication
(10) Pub. No.: US 2024/0014491 A1
(43) Pub. Date: Jan. 11, 2024

(54) BOTTOM OF STEEL BATTERY TRAYS FOR ELECTRIC VEHICLES

(71) Applicant: CONSTELLIUM NEUF-BRISACH, Biesheim (FR)

(72) Inventors: David BARBIER, Grenoble (FR); Jocelyne LIST, Saint Egreve (FR); Jean-Philippe MASSE, Grenoble (FR)

(21) Appl. No.: 18/246,189

(22) PCT Filed: Sep. 23, 2021
(86) PCT No.: PCT/FR2021/051636

§ 371 Date: Mar. 22, 2023

(30) Foreign Application Priority Data
Sep. 24, 2020 (FR) 2009737

(51) Int. Cl. H01M 50/224; H01M 50/233

(52) U.S. Cl. CPC H01M 50/224; H01M 50/233; H01M 2220/20

(57) ABSTRACT

The invention relates to battery trays for electric or hybrid vehicles. The bottoms of the battery trays are made of a thin sheet of steel whose modulus of elasticity is higher than 220 GPa in order to optimize the thickness while ensuring resistance to intrusion.

### FIELD OF THE INVENTION

The present invention relates to the field of vehicles with an electric motor or with a hybrid motor.

More particularly, the present invention relates to the battery trays of such a vehicle with an electric motor or with a hybrid motor, consisting of a peripheral frame having a generally polygonal shape in a plan view, a bottom connected to the lower surface of the peripheral frame and made of steel, as well as an upper cap for closure.

### PRIOR ART

A battery tray or battery tray may comprise a chamber housing electrical energy storage cell element units, allowing producing the electrical energy used for the operation of the electric or hybrid vehicle. The electrical energy storage cell element units are placed in the battery tray, after which the battery tray is mounted on board a vehicle with an electric or hybrid motor.

A vehicle with an electric motor or a hybrid vehicle (a vehicle with an electric motor that also has an internal combustion engine) requires a large number of batteries to run a motor. The references EP 1939026, US 2007/0141451, US 2008/0173488, US 2009/0236162 and EP 2623353 give a few examples of conventional battery trays for electric vehicles.

A battery tray must protect the battery cells used to store electrical energy. In particular, in the event of an accident, this protection must avoid a short-circuit causing a complete breakdown of the vehicle. A battery tray must also have a Faraday cage function to avoid electromagnetic radiations.

Consequently, a battery tray should have sufficient mechanical characteristics to protect the modules in the event of impacts due to a collision. CN106207044 discloses a battery tray made of a carbon fiber composite material, formed by intermediate layers of carbon fibers and laminated PVC foam and side impact resistance performances. CN205930892 discloses a utility model which involves a honeycomb baffle structure instead of the bottom portion in order to improve safety performances in the event of a collision. EP2766247 suggests using trays and a free deformation space between the side wall of the battery sub-compartment and the longitudinal beam of the body of the vehicle.

The patent application CN108342627 discloses a battery tray for an electric vehicle made from the following raw materials, expressed in parts by weight: 0.4-0.9 part iron, 0.5-0.8 part titanium, 0.7-1.3 parts zinc, 0.2-0.6 parts silicon, 3-6 parts nickel, 4-8 parts copper, 1-3 parts manganese, 80-90 parts aluminum, 0.2-0.6 part boron carbide, 0.8-1 part chromium oxide, 0.2-0.25 part magnesium oxide, 0.2-0.5 part silicon oxide, 0.2-0.5 part titanium oxide, 0.2-0.5 part yttrium oxide, 0.02-0.05 part beryllium carbide, 0.02-0.05 part zirconium carbide and 0.02-0.05 part tungsten carbide.

The patent application CN107201464 discloses an electric automobile battery tray made, by weight, from 0.4-0.9 parts iron, 0.5-0.8 parts titanium, 0.7-1.3 part zinc, part silicon, 0.1-0.15 part titanium, 3-6 parts nickel, 4-8 parts copper, 1-3 parts manganese and 80-90 parts aluminum.

The patent application CN107760162 discloses a high-strength and corrosion-resistant battery tray for a passenger car, comprising a body, the latter being made of a high-strength alloy. The surface of the body of the battery tray is coated with a layer of corrosion-resistant coating. The aluminum alloy is prepared from the following components, in percentage by weight content: 0.21-0.47% Mn, 1.83-3.75% Cu, 0.23-0.47% Ti, 2.35-7.48% SiC, 0.13-0.54% Er and the remainder consisting of pure aluminum and trace impurities.

The object of the patent JP4867257 discloses a thin sheet of high-strength steel having a tensile strength of 590 MPa or more, an elasticity ratio of 0.65 or more, and a Young's modulus of 225 GPa or more and an excellent rigidity, and a method for producing the same and the manufacturing method thereof. The solution contains the following elements, in weight %, C: 0.05 to 0.20%, Si: 1.5% or less, Mn: 1.0 to 2.5%, P: 0.05% or less, S: 0.01% or less, Al: 1.5% or less, N: 0.01%, and the remainder being Fe and unavoidable impurities, has an average particle size of the ferrite phase of 5 μm or less, a microstructure wherein the ferrite phase is present in a surface ratio of 50% or more, and is a steel sheet.

The patent EP2064360 discloses a steel sheet which comprises (in weight %) carbon (0.01-0.2), manganese (0.06-3), silicon (=1.5), aluminum (0.005-1.5), phosphorous (=0.04), titanium (2.5-7.2) and boron according to a formula given in the description part, possibly with other elements such as nickel (=1), molybdenum (=1), chromium (=3), niobium (=0.1), vanadium (=0.1) and iron and impurities (the remainder), where the impurities are unavoidable impurities resulting from production. Independent claims are included for: (1) an object manufactured from steel parts with identical or different composition and thickness, wherein at least one of the steel parts is the given steel sheet, welded together; (2) a manufacturing method comprising providing steel compositions and casting steel in the form of a semi-finished product; and (3) the production of structural parts, comprising cutting a blank of a steel sheet or of an object and the deformation of the blank at 20-900 [deg] C.

According to the presentation of the Novelis company, held in the context of the “Materials in car body engineering” conference on May 16, 2018 in Bad Nauheim, lightening of the battery trays is achieved with aluminum sheets with high yield strength.

According to the presentation of the Arcelor company, held in the context of the “Battery systems in car body engineering” conference on Jun. 28, 2019 in Bad Nauheim, lightening of the battery trays is achieved with steels with very high yield strength.

A battery tray must also be perfectly sealed in order to prevent the penetration of fluid inside the chamber of the battery tray or the leakage of the electrolyte contained in the electrical energy storage cell elements outside of the chamber of the battery tray. In particular, a waterproof sealing is mandatory if the battery tray is fastened below the floor of the vehicle, in order to prevent the penetration of water or mud. In addition, it is necessary to provide for corrosion resistance against incoming and outcoming fluids.

In order to improve the operating performances of a vehicle, a battery tray must have a reduced weight while simultaneously offering maximum impact resistance, tight sealing, resistance to corrosion, ability to adapt to the control of temperature and an ability to accommodate as many electrical energy storage cell elements as possible.

The present invention has been developed to lighten the bottom of the battery tray for vehicles with an electric or hybrid motor. The main function of this area of the tray is to protect the electrical energy storage cells and their cooling system from intrusions from the road (liquids and solids). The present invention suggests using an aluminum alloy sheet. Indeed, this solution allows ensuring a good functional response, by simultaneously offering perfect sealing over a large surface (no connections necessary) and structural performance which allows limiting the intrusions of objects with high kinetic energy, as well as high stability of the performances over time (little or no change in properties over time, high structural resistance to corrosion in the concerned environment), and finally an optimized weight.

### PROBLEM

The present invention aims to define metallic materials made of steel for battery trays having good properties against intrusion.

### OBJECT OF THE INVENTION

An object of the invention is the use of a thin sheet of steel whose modulus of elasticity is at least 220 GPa to make a battery tray bottom.

### DESCRIPTION OF THE FIGURES

FIG. 1 is an exploded view of a battery tray for a vehicle with an electric or hybrid motor, in the case where the bottom is a part separate from the peripheral frame.

FIG. 2 shows the experimental setup of the penetration test.

FIG. 3 shows the numerical simulation model with the impactor.

### DESCRIPTION OF THE INVENTION

The tensile static mechanical characteristics, in other words the breaking strength Rm, the conventional yield strength at 0.2% elongation Rp0.2, the necking elongation Ag % and the breaking elongation A %, are determined by a tensile test according to the standard NF EN ISO 6892-1, the sampling and direction of the test being defined by the standard EN 485-1.

The modulus of elasticity, also called Young's modulus, is measured according to the standard ASTM 1876.

Unless specified otherwise, the definitions of the standard EN 12258 apply. A thin sheet is a rolled product with a rectangular cross-section whose uniform thickness is comprised between 0.20 mm and 6 mm.

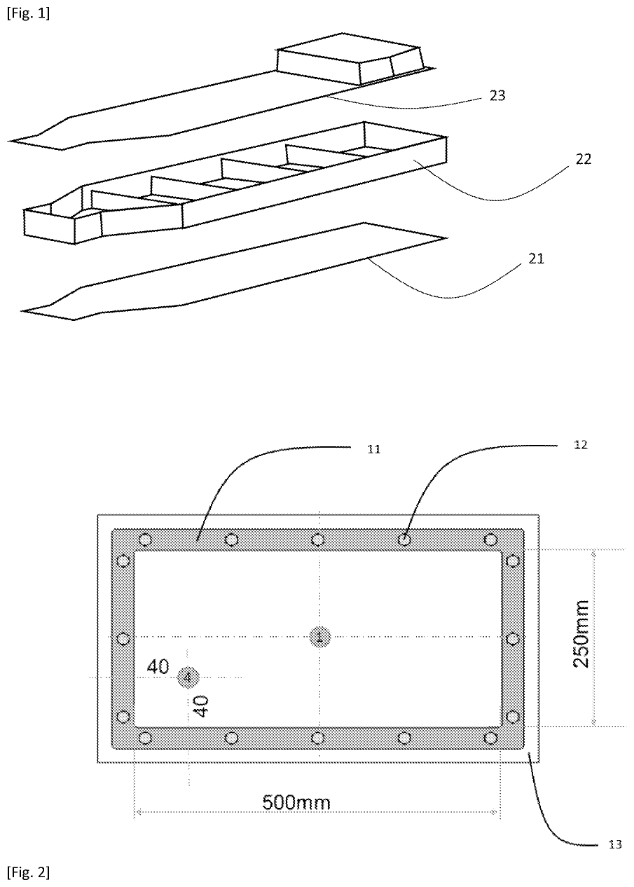

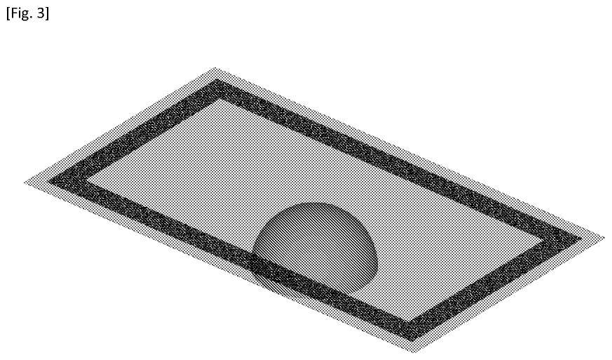

FIG. 1 shows a non-limiting example of a battery tray for vehicles with an electric or hybrid motor comprises a bottom 21, an external peripheral frame 22 formed so as to be positioned on an external portion of a peripheral edge of the bottom 21 and an upper heavy sheet or cap 23 placed on the peripheral frame from above. The external peripheral frame 22 is commonly connected to the bottom 21 by assembly means such as welding or gluing in order to guarantee the resistance of the assembly and sealing of the edges between the lower portion and the peripheral frame. The external peripheral frame has a primarily polygonal shape. The upper cover is assembled on the peripheral frame by assembly means like, as non-limiting examples, rivets, gluing, welding or screws. It may also be fastened hermetically. The entirety of the peripheral frame 22 and of the bottom 21 may also consist of a part obtained from the deformation of a sheet, as a non-limiting example, by stamping.

The main structural function of the bottom plate is protection against the intrusion of road objects onto the battery tray. Hence, the principle is to protect the batteries of the battery tray against damages. The Inventors have sought to identify the most suitable steel materials for a battery tray. The typical selection criterion for defining the best materials is to obtain the greatest energy absorption for a deformation of the battery tray bottom under the effect of an impactor or the greatest intrusion force of an impactor for the same deformation of the battery tray bottom. They have proceeded in several steps: the first consisted in carrying out numerical simulations with different virtual materials. A virtual material is a material defined only by its mechanical properties without worrying about whether it could exist a priori. These mechanical properties are the modulus of elasticity, the yield strength Rp0.2 and the stress and strain curves. The second step has consisted in defining the selected virtual materials by looking for the composition and the manufacturing process that allow obtaining the selected properties. These steps have been naturally repeated a certain number of times to obtain the most effective real materials for lightening the battery tray bottom.

Usually, increasing the yield strength Rp0.2 of a material is a conventional means for thinning a part made with said material. Surprisingly, the Inventors have shown that it is also relevant to increase the modulus of elasticity to improve the properties of the battery tray bottoms. For a thin sheet of steel, usually, the modulus of elasticity is typically 210 GPa.

Hence, a battery tray bottom according to the invention uses a thin sheet of steel whose modulus of elasticity is at least 220 GPa.

In a preferred embodiment of the invention, the thin sheet of steel used for the battery tray bottom has a modulus of elasticity of at least 225 GPa, more preferably at least 230 GPa, more preferably at least 235 GPa, more preferably at least 239 GPa.

In a preferred embodiment, the thin sheet of steel used for the battery tray bottom has a yield strength Rp0.2 higher than 350 MPa, preferably higher than 400 MPa, more preferably higher than 800 MPa, more preferably higher than 1,000 MPa, more preferably higher than 1,200 MPa.

### Examples

A specific penetration test has been designed to assess the resistance to penetration of the bottom 21. To assess the resistance to penetration of the sheet material, two critical configurations on the bottom sheet 21 can be used, which form a near penetration and a far penetration of the external peripheral frame. Proximate to the frame, the mechanical system is rigid and enables only a slight deformation of the sheet during the penetration. In this manner, the fracture of the material is the dominant damage mechanism. In a central position, away from the frame, the system behaves elastically. It could be the site of elastic and plastic deformations, leading to a high risk of contact of the sheet with the battery modules. The test may be performed on a Zwick 400 static load testing machine. As shown in FIG. 2, the sheet 13 is clamped between an upper steel frame and a lower steel frame 11 with a mm width and fastened by means of several screws 12. A 19.6 mm in diameter cylindrical mandrel with rounded edges (r=1.5 mm) is fastened on the machine to is perform a penetration in the sheet. The force applied to the mandrel as well as its displacement are measured. The frame can move so as to control two positions amongst the same central reference 1 and angular reference 4 positions of the sheet. The total movement of the mandrel during the test is set at a distance of 15 mm selected to represent a typical space between the bottom 21 and the batteries. The test is performed under quasi-static conditions.

The above-described intrusion test requires having a material to be tested. The Inventors have sought to identify the most suitable steel materials for lightening a battery tray bottom. Hence, the Inventors have defined the properties of virtual materials in order to identify the most promising ones in order to lighten the mass of a battery tray bottom. The properties of the virtual materials are modulus of elasticity, the yield strength, and the stress and strain curves. These data are summarized in Tables 1 and 2.

These different properties of the materials have been used in numerical simulation to study their resistance to intrusion using a simplified battery tray bottom. The numerical simulation software is LS-Dyna. The simplified battery tray bottom is a 350*600 mm sheet. The mesh for the simulation uses elements with a length of 2.5 mm, “fully integrated shell element” with 5 integration points in the thickness. The boundary conditions for the numerical simulation have two characteristics. The first one is a 30 mm wide strip at 20 mm inside the sheet starting from the edge, where only translations in the plane of the sheet and the rotation around the vertical axis are authorized. A second feature is the presence of 16 areas with a 10 mm diameter distributed around the sheet to represent the screw areas, where all translations and all rotations are blocked on the nodes. The plane of FIG. 2 shows this strip and these 16 areas.

The primary structural function of the bottom plate is intrusion protection against road objects projected onto the battery tray. Hence, the principle is to protect the batteries of the battery case against damages.

The numerical approach is the simulation of the quasi-static intrusion test, with a spherical impactor with a 150 mm diameter. The Inventors used a 150 mm diameter spherical impactor rather than a 19.6 mm diameter cylindrical mandrel with rounded edges because it is closer to a real object that might hit the battery tray in reality. The simulation is performed up to a displacement of the punch by 15 mm at the center of the sheet at constant speed and the reaction force on the punch is calculated. The curves between the different material options are compared.

The comparison in Table 2 between the steel 1 and the steel 2 shows that increasing the modulus of elasticity by 30 GPa allows thinning the steel sheet by 5.6%.

The comparison in Table 2 between the steel 3 and the steel 4 shows that increasing the modulus of elasticity by 30 GPa allows thinning the steel sheet by 9.1%. Increasing the yield strength of a steel with a high yield strength like the steel 3 is much more interesting than on a steel like the steel 2.

The steel thin sheet of the patent JP4867257 is an example of a steel thin sheet that is suitable for the invention.

The steel thin sheet of the patent EP2064360 is an example of a steel thin sheet that is suitable for the invention.

TABLE 1

| | |
|---|---|
| Steel 3 and 4 | Steel 1 and 2 |

| strain [—] | stress [MPa] | strain [—] | stress [MPa] |
|---|---|---|---|
| 0.000 | 1200 | 0.000 | 300 |
| 0.001 | 1269 | 0.001 | 369 |
| 0.002 | 1285 | 0.002 | 385 |
| 0.002 | 1294 | 0.002 | 394 |
| 0.003 | 1304 | 0.003 | 404 |
| 0.004 | 1327 | 0.004 | 427 |
| 0.006 | 1354 | 0.006 | 454 |
| 0.010 | 1386 | 0.010 | 486 |
| 0.016 | 1423 | 0.016 | 523 |
| 0.025 | 1465 | 0.025 | 565 |
| 0.040 | 1512 | 0.040 | 612 |
| 0.063 | 1564 | 0.063 | 664 |
| 0.100 | 1619 | 0.100 | 719 |
| 0.150 | 1668 | 0.150 | 768 |
| 0.200 | 1702 | 0.200 | 802 |
| 0.250 | 1728 | 0.250 | 828 |
| 0.300 | 1749 | 0.300 | 849 |
| 0.400 | 1779 | 0.400 | 879 |
| 0.500 | 1800 | 0.500 | 900 |
| 0.600 | 1816 | 0.600 | 916 |
| 0.700 | 1829 | 0.700 | 929 |
| 0.800 | 1838 | 0.800 | 938 |
| 0.900 | 1846 | 0.900 | 946 |
| 1.000 | 1853 | 1.000 | 953 |

TABLE 2

| | | E | Rp0.2 | Rm | Thickness | Thickness |
|---|---|---|---|---|---|---|
| | | (GPa) | (MPa) | (MPa) | (mm) | gain |
| | Steel 1 | 210 | 400 | 650 | 1.8 | |
| Invention | Steel 2 | 240 | 400 | 650 | 1.7 | 5.6% |
| | Steel 3 | 210 | 1300 | 1450 | 1.1 | |
| Invention | Steel 4 | 240 | 1300 | 1450 | 1.0 | 9.1% |

1. A product comprising a thin sheet of steel comprising a modulus of elasticity of at least 220 GPa, said product being suitable to make a battery tray bottom.

2. The product according to claim 1, wherein the modulus of elasticity of said thin sheet of steel is at least 225 GPa, optionally 230 GPa, optionally 235 GPa.

3. The product according to claim 1, wherein the yield strength Rp0.2 of said thin sheet of steel is higher than 350 MPa, optionally higher than 400 MPa, optionally higher than 800 MPa, optionally higher than 1,000 MPa, optionally higher than 1,200 MPa.
